(19) United States
(12) Patent Application Publication
(10) Pub. No.: US 2021/0158271 A1
(43) Pub. Date: May 27, 2021

(54) DETERMINING SEASONALITY IN INTERMITTENT INVENTORY DEMAND

(71) Applicant: Right Sized Inventory, Corrales, NM (US)

(72) Inventors: Stephen Cook, Albuquerque, NM (US); David McPhetridge, Oceanside, CA (US)

(21) Appl. No.: 16/691,373

(22) Filed: Nov. 21, 2019

(51) Int. Cl. G06Q 10/08; G06Q 10/06; G06N 7/00

(52) U.S. Cl. CPC G06Q 10/087; G06N 7/00; G06Q 10/06315

(57) ABSTRACT

In a method for determining seasonality in inventory demand, an inventory analytics engine uses a frequency of reordering to identify a micro-season for an inventory item. The inventory analytics engine further uses linear regression analysis to identify a variable most closely associated with the micro-season. The inventory analytics engine adjusts a reordering schedule to accommodate an expected demand for the inventory item.

### FIELD OF THE INVENTION

The field of the invention is inventory management and predictive analytics.

### BACKGROUND

When a company has a large inventory of products to move, sell, and/or buy, inventory managers typically estimate the inventory level required to adequately satisfy inventory demand. Computer systems for inventory management can be helpful in visualizing inventory availability and providing different data points. For example, an inventory manager can use a computer system for inventory management to extract particular data points or make simple connections between data points and provide specific answers to specific inquiries. However, conventional systems do not make higher-level inferences from the data points in order to improve inventory management. For example, conventional systems can provide particular data points requested by a user, such as total sales, returns, and reorder amount, but fail to identify less conventional connections between inventory trends and their effects on inventory management.

Further, in these conventional systems the inventory manager scheduled and allocated inventory by making inferences from inventory data. For example, a conventional inventory management system can determine seasonality based on metrics directly tied to inventory, such as inventory levels, reorder frequency, and reorder amounts. However, the number of variables affecting inventory demand often very numerous for people to make reliable inferences. For example, conventional inventory management consists of inferences made by an inventory manager based on readily identifiable seasons, including for example, holidays and conventional seasons (e.g., winter, summer, fall, and spring). Additionally, inventory demand can be affected by one or more unobvious factors, such as factors that are not associated with conventional seasons and holidays. Lastly, determining intermittent demand based on limited metrics, such as using the reorder point as the sole variable, does not anticipate unconventional inventory patterns that may be caused by an interaction of many variables, including many that are indirectly related to the particular product (e.g., supply-chain variables).

Seasonality can be determined using conventional methods, but would take a significant amount of time and resources to determine unconventional seasons, such as, for example, micro-seasons that are prompted by unconventional factors. Micro-seasons are associated with increased movement of inventory where the increase is not clearly associated with one or more conventional factors. For example, a micro-season can be defined by a sudden uptick in the sales of a particular good outside of the normal shopping season (e.g., Thanksgiving and Christmas). In another example, a micro-season can be indicated by an uptick in the sales of a boat neck tops, which is influenced by an unconventional factor such as a sighting of boat neck tops at a celebrity event.

Conventional factors can include factors such as the time of year, the type of good, and the color of the goods. In contrast, unconventional factors can be any factor that is not typically associated with seasonality. For example, unconventional factors affecting one or more rises or declines in the inventory sales can include, but are not limited to, current events, social trends, scarcity of raw materials, local events, weather, regional preferences, and cultural preferences. It is contemplated that the present invention can consider any number of conventional and unconventional factors in determining seasonality.

U.S. Pat. No. 6,205,431 to Willemain teaches a system and method for forecasting intermittent demand for a lead time by determining a reorder point and an order quantity. Willemain, however, discloses a method that relies on metrics only associated with the inventory to determine intermittent demand, but does not determine seasonality based on one or more directly and/or indirectly related factors. As such, Willemain determines seasonality based on inventory reorder lead times without considering additional factors, such as, for example, the effects of upstream inventory requirements on downstream inventory requirements and the effects of regional factors on intermittent demand. Consequently, Willemain does not address the many additional factors affecting intermittent demand.

Willemain and all other extrinsic materials discussed herein, are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for methods and systems that accurately determines intermittent demand and adapt to unconventional inventory patterns.

### SUMMARY OF THE INVENTION

The presently claimed system determines seasonality by identifying one or more inventory trends associated with one or more inventory items to predict demand. The presently claimed system also executes one or more actions responsive to determining the demand levels for items in an inventory.

In an illustrative embodiment, the present invention uses a frequency of reordering to identify a micro-season for an inventory item. Following the identification of a micro-season, the present invention uses a linear regression analysis to identify a variable most closely associated with the micro-season, and adjusts a reordering schedule to accommodate an expected demand for the inventory item.

As used herein, an “inventory” is any tangible item or service, whether physical or virtual, living or nonliving. Examples include consumer goods, time associated with the provision of services, and any other trackable service or good. Each inventory item typically has a series of unique and non-unique attributes that are associated with the inventory item. As the terms imply, unique attributes are attributes that are unique to that particular inventory item, and non-unique attributes are attributes that can be common by more than one inventory item. For example, if the inventory item is only available at particular times of the year (e.g. produce that only grows during particular seasons during the year), then the yearly availability of the inventory item is an attribute of the inventory item. Inventory items are not limited to tangible good and can comprise services.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a method of determining expected demand levels for a product by analyzing product developments over time.

FIG. 2 is a schematic of a method of using expected demand values to determine and prompt execution of one or more actions.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including facilitating the scheduling of events, facilitating the efficient manufacture of one or more goods, and any other application of genetic algorithms known in the art.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

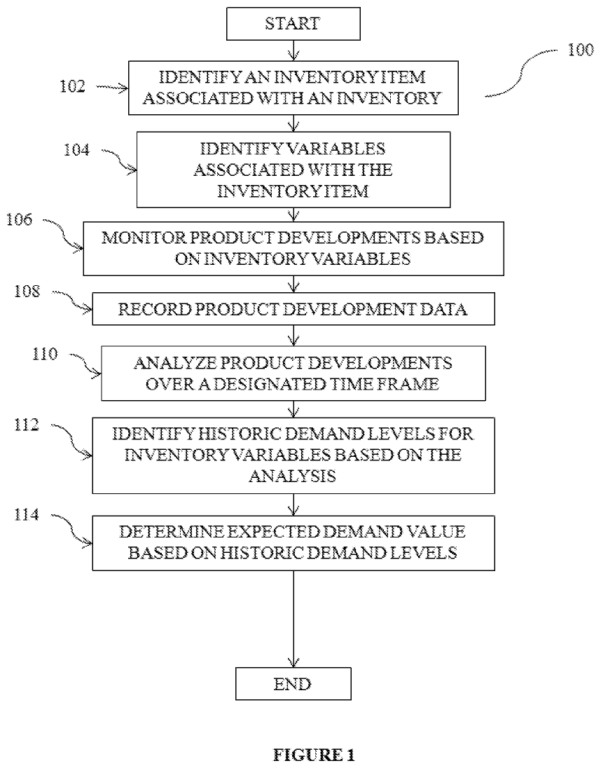

FIG. 1 is a schematic of a method of determining expected demand levels for a product by analyzing product developments over time.

Inventory analytics engine 100 identifies one or more inventory items compiled into an inventory (step 102).

As defined herein, an inventory is any combination of goods and/or services collectively associated with an entity.

Inventory analytics engine 100 uses one or more precompiled lists of inventory items associated with an inventory. In another embodiment, inventory analytics engine 100 can determine one or more inventory items based on at least one variable associated with the inventory items to compile an inventory. For example, inventory analytics engine 100 can compile inventory items that comprise a proprietary polymeric material used for research and development purposes into a research and development inventory.

Alternatively, inventory analytics engine 100 can use machine learning techniques to analyze which characteristics of one or more inventory items can be categorized into discrete inventories. For example, inventory analytics engine 100 can use a supervised learning classifier to infer a function from labeled training data (e.g., set of training examples). In another example, inventory analytics engine 100 uses time-series forecasting to determine that items received during a particular time frame are associated with a particular inventory. It is contemplated that inventory analytics engine 100 can use any technique known in the art to analyze characteristics of the inventory items to categorize into discrete categories.

Inventory analytics engine 100 identifies inventory variables associated with the inventory item (step 104).

Inventory variables can comprise any measurable variable associated with an inventory item. For example, inventory variables can include, but are not limited to, reorder points, current inventory level, historical inventory levels, colors, shapes, sizes, associated products, raw materials, upstream manufacturing requirements, downstream manufacturing requirement, service requirements, purchase trends, delivery times, manufacturing deadlines, and stock outs.

In some embodiments, inventory variables are pre-designated. For example, inventory variables for raw materials used in the production of an alloy car frame can be pre-designated to include, historical reorder points for steel, historical reorder points for aluminum, current raw steel stock, current raw aluminum stock, and downstream manufacturing requirements. In this example, inventory variables can exclude information that is irrelevant to managing the inventory (e.g., colors).

Alternatively, inventory analytics engine 100 can use machine learning techniques to analyze which characteristics of one or more inventory items comprise relevant variables for inventory management. For example, inventory analytics engine 100 can use a supervised learning classifier to infer a function from labeled training data (e.g., set of training examples). In another example, inventory analytics engine 100 uses time-series forecasting to determine that inventory variables tied to a winter-time do not rise to an adequate level of relevance between the months of March and September to be considered. It is contemplated that inventory analytics engine 100 can use any technique known in the art to determine which inventory variables are to be considered for inventory management.

Inventory analytics engine 100 monitors product inventory item developments based on the inventory variables (step 106).

It is contemplated that inventory analytics engine 100 can monitor inventory developments from historical data and/or from current inventory data based on inventory variables. It is further contemplated that inventory analytics engine 100 can monitor inventory developments based on each inventory item's respective variables.

It is contemplated that the inventory variables can be determined by inventory objectives. Inventory objectives can be any one or more objectives of inventory analytics engine 100 in managing inventory. In some embodiments, inventory priorities can be determined by inventory analytics engine 100 by any means, including, for example, machine learning algorithms. In other embodiments, the inventory priorities can be directly defined by a user of inventory analytics engine 100. In yet other embodiments, inventory analytics engine 100 can monitor inventory item developments based on a group of a plurality of groups of inventory variables associated with different inventory priorities.

In one embodiment, inventory analytics engine 100 monitors inventory item developments as they arise. For example, inventory analytics engine 100 can monitor reorder logs of a particular widget required to build a car.

In preferred embodiments, inventory analytics engine 100 monitors both historical inventory item data and current inventory developments based on the inventory variables. In an example where the inventory item are components of a shoe, inventory analytics engine 100 can derive inventory developments from historical inventory item data associated with the laces, the sole, the leather, and the plastic widgets in order to determine historical trends associated with the shoes. In this example, inventory analytics engine 100 can monitor the reorder points, shipping times, and inventory level for different colors of leather and plastic widgets for each color, and monitor the sole and the laces (in this example, always the same color, in large supply, and easily sourced) based only on historic reordering activity.

It is contemplated that inventory analytics engine 100 can retrieve information regarding product developments from one or more sources. For example, inventory analytics engine 100 can retrieve product developments from a shared database, directly from a source, and/or in regularly scheduled intervals. However, the claimed invention is not limited to the aforementioned sources and can retrieve relevant product development information using any means known in the art.

By prioritizing or solely focusing on relevant variables when monitoring one or more inventory items, inventory analytics engine 100 can advantageously use fewer resources to monitor one or more inventory items. In contrast, conventional inventory monitoring systems can monitor less relevant variables as well as relevant variables to manage inventory, thereby requiring more resources to monitor inventory developments and convoluting data that is most relevant to determining how to manage inventory stock supply.

As such, by focusing inventory items based on variables that are highly relevant to inventory management, inventory analytics engine 100 advantageously saves significant amounts of time and resources by reducing the workload of inventory analytics engine 100 to focus on relevant priorities. For example, inventory analytics engine 100 can target variables that maximize reserve inventory levels for high volume consumable goods without having to monitor variables associated with upstream production if the consumable good is directly-sourced raw material.

In another example, inventory analytics engine 100 can target variables that maximizes the likelihood of stockout for goods that are only available for a limited time, including, for example, a dress that is only sold for one season. In this example, inventory analytics engine 100 can adjust order and reorder points based on variables, such as color, size, fabric, identified trends, sales of similar goods, and branding, in order to maximize the likelihood of all the inventory being sold out before the close of the season.

Inventory analytics engine 100 records product development data (step 108).

Product development data can include any data associated with one or more inventory items. In one embodiment, product development data can include directly monitored data, such as reordering frequency, quantity of goods per order, sales, and any other core metric.

It is also contemplated that product development data can include any data derived from higher level analyses. For example, product development data can include data derived from calculating correlations between sales of a first item and a second item. In another example, product development data can include data derived from correlating the color of a good and the size of a good with reorder points. In this example, product development data can correlate lighter colors with fewer sales at larger sizes, which can be caused indirectly by a common preference for darker colors to make larger frames appear slimmer.

It is contemplated that inventory analytics engine 100 can store product development data in any manner known in the art. In one example, inventory analytics engine 100 can record product development data directly to one or more hard drives. In another example, inventory analytics engine 100 can record product development data to a remote server using cloud-based technologies. In yet another example, inventory analytics engine 100 can record product development data using a mixture of directly connected data storage devices and remote hardware over a cloud computing infrastructure.

In yet another embodiment, product development data can be fully provided by an external entity. For example, a user of inventory analytics engine 100 can input product development data for a product directly. In another embodiment, a user of inventory analytics engine 100 can input some product development data directly into inventory analytics engine 100, and allow the remainder of the product development data to be derived from another source. For example, a user of inventory analytics engine 100 can input product development data for a particular time frame, and inventory analytics engine 100 can collect product development data from the end of the particular time frame to the present. However, product development data can be provided in any manner known in the art.

Inventory analytics engine 100 analyzes product development data over a designated time frame (step 110).

The designated time frame can include any time frame having a definite start date. In some embodiments, the time frame can be a time frame with a start date and an end date, such as, for example, a time period from May to August in the preceding year. In other embodiments, the time frame can be open-ended, such that there is a start date with no end date. In an embodiment where the time frame is open-ended, it is contemplated that inventory analytics engine 100 can continuously analyze the product development data as new product development data is received.

It is contemplated that inventory analytics engine 100 can analyze product development data in any manner known in the art. For example, the analytical framework can be one or more of descriptive, exploratory, inferential, predictive, causal, and mechanistic. However, inventory analytics engine 100 is not limited to the aforementioned analytical frameworks, and can employ any one or combination of analytical frameworks known in the art. Additionally, machine learning algorithms can learn in any manner known in the art, including, for example, by using supervised learning, unsupervised learning, semi-supervised learning, and/or reinforcement learning.

Using a descriptive analytical framework, inventory analytics engine 100 can analyze the data to quantitatively describe the main trends in a collection of data.

Using an exploratory analytical framework, inventory analytics engine 100 can analyze data sets to find previously unknown relationships. For example, inventory analytics engine 100 can use one or more algorithms, including, for example, machine learning algorithms such as time-series models, supervised learning classifiers, and linear regression analyses, to determine a connection between two seemingly unrelated inventory items (e.g., finding a connection between decreased supplies of graphics cards and decreased supplies of surge protectors during cryptocurrency mining booms).

Using an inferential analytical framework, inventory analytics engine 100 can analyze a representative subgroup of data sets to make inferences about a bigger population. For example, inventory analytics engine 100 can analyze a data set representing inventory demand in a community that has similar demographics to a state in order to determine reordering points for various inventory items.

Using a predictive analytical framework, inventory analytics engine 100 can analyze current and historical data to make predictions about future events. Predictive analytical frameworks can include the use of supervised learning classifiers, time-series forecasting, and any other machine-learning algorithms.

In one example, inventory analytics engine 100 can review historical product development data to determine which products are likely to fluctuate similarly in demand using supervised learning classifiers. Specifically, inventory analytics engine 100 can review designated categories of inventory items based on training data inputted by a user to determine which categories of inventory items will behave similarly to particular market forces. It is contemplated that using supervised learning classifiers allows inventory analytics engine 100 to make inferences from the data based on what is taught by the training data in order to analyze unexpected situations in a more reasonable way (e.g., come to conclusions that a human being might come to).

In another example, inventory analytics engine 100 can use time-series forecasting to predict the seasonality of particular inventory items. For example, inventory analytics engine 100 can determine that lighter color choices for t-shirts historically sell better from March to August. Inventory analytics engine 100 can use this determination and apply it to new styles of shirts to be sold later in the year to predict if and when higher demand for lighter colored shirts will occur.

Using a causal analytical framework, inventory analytics engine 100 can adjust one variable in a real or hypothetical situation to determine how it affects another variable. For example, inventory analytics engine 100 can determine how reducing the supply of a particular brand affects the sales of a competing brand (e.g., whether the reduction of the supply will actually cause people to switch brands) in order to predict consumer behavior in response to future inventory actions. It is contemplated that the causal analysis in the preceding example can help determine whether consumers are more tied to the type of product or to the brand.

In some embodiments, inventory analytics engine 100 can use a mechanistic analytical framework, which is used to understand the exact effects of how changing a variable leads to changes in other variables for one or more inventory items.

Inventory analytics engine 100 identifies historic demand levels associated with inventory variables based on the analysis of the product development data (step 112). Based on the product development data, inventory analytics engine 100 identifies historic demand levels associated with one or more inventory variables.

For example, inventory analytics engine 100 can identify historic demand levels for a particular color in the clothing space. In another example, inventory analytics engine 100 can identify historic demand levels for gold in the chip fabrication space. It is contemplated that inventory analytics engine 100 can identify historic demand levels for any variable applied to every inventory item, particular types of inventory items, and specific items.

Inventory analytics engine 100 determines an expected demand value for one or more inventory variables associated with one or more inventory items (step 114).

Demand values can be any representation or combination of representations that indicate the level of demand for an item. For example, demand values can be represented by a numerical score that is determined by using an algorithm to weigh multiple factors. In some embodiments, demand values can be a composite score. It is also contemplated that demand values can comprise a combination of individual scores representing multiple categories.

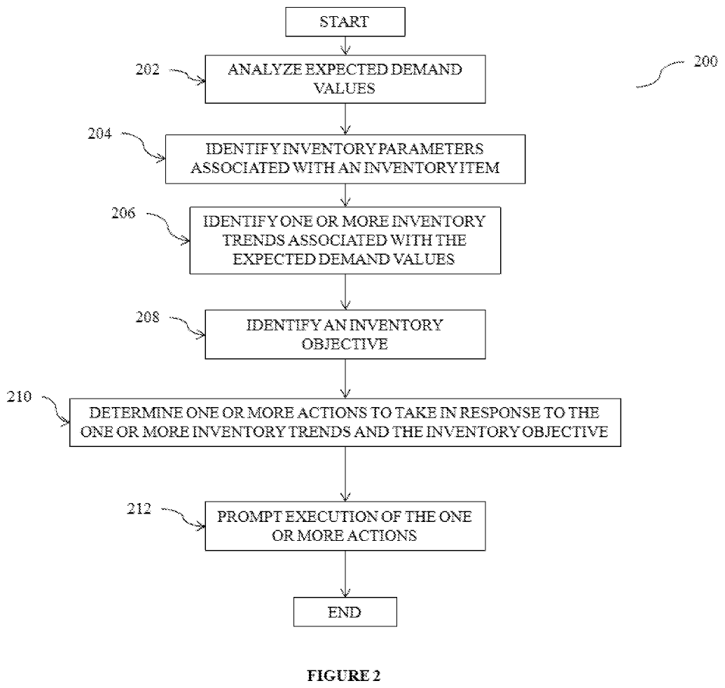

FIG. 2 is a schematic of a method of using expected demand values to determine and prompt execution of one or more actions.

Inventory analytics engine 100 identifies inventory parameters associated with an inventory item (step 202).

It is contemplated that inventory parameters are characteristics of inventory items. It is further contemplated that inventory parameters can be one of multiple characteristics associated with an inventory variable. For example, a blue cami can be associated with the characteristics blue, tank top, female, and summer, each of which are associated with the categories color, clothing type, gender, and season, respectively.

Inventory analytics engine 100 analyzes expected demand values associated with the inventory item (step 204).

It is contemplated that inventory analytics engine 100 analyzes the expected demand value associated with an inventory item based on the one or more inventory parameters. For example, inventory analytics engine 100 can analyze the expected demand values for the color blue, tank tops, females, and the summer season.

By analyzing each of these metrics, inventory analytics engine 100 can determine the expected demand for an inventory item holistically, rather than by simply associating a demand level with a specific inventory item. However, it is also contemplated that inventory analytics engine 100 can determine an expected demand value for an inventory item without considering multiple characteristics.

Inventory analytics engine 100 identifies one or more inventory trends associated with the expected demand values (step 206).

The present invention contemplates that inventory trends can comprise anything that indicates or helps in indicating the amount of demand that exists for an inventory item. Inventory trends can be identified by any means known in the art. For example, time-series forecasting and a linear regression analysis can be used for trend analysis.

Linear regression is a linear approach to modeling the relationship between a scalar response (or dependent variable) and one or more explanatory variables (or independent variables).

In a first example, inventory analytics engine 100 can be tasked with identifying the inventory trends associated with a brown leather sandal from Brand X. Inventory analytics engine 100 can identify from the expected demand values that the color brown is declining in popularity during the summer, leather is consistently in lower demand during the summer, and sandals increase in demand during the summer. Inventory analytics engine 100 can also identify that people who purchase Brand X do so consistently throughout the year based on the demand for the brand itself regardless of the characteristics of the inventory item. By weighing all of these factors, inventory analytics engine 100 can, for example, identify that brown leather sandals require a sight inventory adjustment downwards for the upcoming summer season.

In a second example, inventory analytics engine 100 can identify trends associated with shoes by Brand Y. Inventory analytics engine 100 can determine that Brand Y is associated with high polarity in consumer sentiment as a result of Brand Y's edgier design language and higher prices. Additionally, inventory analytics engine 100 may determine that the overall market is shifting to more conservative spending habits based on decreased sales for non-staple inventory items (e.g., limited editions of a designer jacket) over the past three years.

It is contemplated that inventory analytics engine 100 can use the identified inventory trends to assist in determining one or more actions to take in step 210.

Inventory analytics engine 100 identifies an inventory objective. Inventory objectives can include any objective related to the inventory. (step 208).

In some embodiments, inventory objectives can apply to the whole inventory. In other embodiments, inventory objectives can apply to a sub-group of an overall inventory.

Inventory objectives can be any one or more objectives of inventory analytics engine 100 in managing inventory. In some embodiments, inventory objectives can be determined by inventory analytics engine 100 by any means, including, for example, machine learning algorithms. In other embodiments, the inventory objectives can be directly defined by a user of inventory analytics engine 100. In yet other embodiments, inventory analytics engine 100 can monitor individual groups of inventory item with different respective inventory objectives.

In preferred embodiments, it is contemplated that the inventory objectives are provided by a user of inventory analytics engine 100. For example, a warehouse manager can provide the inventory objecting of minimizing downstream volatility by prioritizing consistent delivery of a raw material that is provided to downstream manufacturers.

However, it is also contemplated that inventory analytics engine 100 can identify inventory objective in any manner known in the art. For example, inventory analytics engine 100 can identify inventory objectives by using machine learning algorithms to learn which factors are the most important to a clothing store.

Inventory analytics engine 100 determines one or more actions to take based on the one or more identified inventory trends and the inventory objective (step 210).

In preferred embodiments, inventory analytics engine 100 can determine one or more actions to take based on the identified inventory trends and the inventory objectives of a plurality of inventories. For example, inventory analytics engine 100 can weigh the inventory trends and the inventory objectives of multiple manufacturers in a vertical manufacturing infrastructure. In this example, inventory analytics engine 100 can determine a course of action after weighing each manufacturer's respective inventory objectives.

In embodiments where inventory analytics engine 100 determines actions for multiple related entities, each entity can be tied together by one or more overarching inventory objectives. For example, in a grocery market chain, the overarching inventory objective can be to minimize the amount of time between the inventory items, such as fresh produce, being put out for sale and being purchase by a consumer.

Inventory analytics engine 100 prompts execution of the one or more actions (step 212).

It is contemplated that inventory analytics engine 100 can prompt the execution of the one or more actions in any manner known in the art.

For example, inventory analytics engine 100 can directly control an inventory management system to automatically make changes to scheduling reorder lead times and inventory quantities. Alternatively or additionally, inventory analytics engine 100 can prompt execution of one or more actions to manage inventory by sending instructions to a human worker to carry out the one or more instructions.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for utilizing micro-seasons in inventory demands, comprising:
using a frequency of reordering to identify a micro-season for an inventory item;
using a linear regression analysis to identify a variable closely associated with the micro-season;
adjusting a reordering schedule to accommodate an expected demand for the inventory item; and
reordering the inventory item according to the reordering schedule.

2. The method of claim 1, wherein the linear regression analysis models the relationship between the variable and one or more explanatory variables.

3. The method of claim 1, further comprising analyzing additional factors to identify additional variables associated with the micro-season.

4. The method of claim 3, wherein at least some of the additional factors are selected from the group consisting of: current inventory levels, historical inventory levels, physical product characteristics, associated products, raw materials, upstream manufacturing requirements, downstream manufacturing requirements, service requirements, purchase trends, delivery times, and manufacturing deadlines.

5. The method of claim 1, wherein monitoring product the frequency of reordering to identify the micro-season is performed at least five times during a 24 hour period.

6. The method of claim 1, wherein monitoring product the frequency of reordering to identify the micro-season is performed least five times during a one week period.

7. The method of claim 1, wherein the inventory item is a service.

8. The method of claim 1, wherein the linear regression analysis determines a connection between multiple inventory items, wherein the connection directly affects inventory levels of each of the multiple inventory items, respectively.

9. The method of claim 1, wherein the inventory item is reordered at a predetermined time interval before the expected demand for the inventory item.

10. The method of claim 1, wherein reordering the inventory item according to the reordering schedule, further comprises causing one or more people to coordinate delivery of the inventory item by a delivery deadline.

11. The method of claim 1, wherein reordering the inventory item according to the reordering schedule, further comprises causing one or more machines to coordinate delivery of the inventory item by a delivery deadline.

12. The method of claim 7, further comprising causing a person to execute a service by a designated deadline.

13. The method of claim 7, further comprising causing a machine to execute a service by a designated deadline.

14. The method of claim 7, wherein the inventory item is a combination of at least one service and at least one good.

15. The method of claim 7, wherein the linear regression analysis determines a connection between multiple services, wherein the connection directly affects service availability of each of the multiple services, respectively.

16. The method of claim 15, wherein the reordering schedule includes multiple service deadlines applying to one or more of the multiple services, such that each service is completed by a respective deadline.

17. The method of claim 8, wherein the reordering schedule includes multiple delivery deadlines applying to one or more of the multiple inventory items, such that each inventory item is delivered by a respective deadline.

18. The method of claim 9, wherein the predetermined time interval is selected from the group consisting of: one year, nine months, six months, three months, two months, one month, three weeks, two weeks, and one week.
